(19) United States
(12) Patent Application Publication
(10) Pub. No.: US 2006/0222440 A1
(43) Pub. Date: Oct. 5, 2006

(54) Process for the production of a pencil and a pencil

(75) Inventors: Reinhard Bauer, Rosstal (DE); Britta Lorenz, Nuremberg (DE); Dieter Schiller, Rosstal (DE)

Correspondence Address: BACHMAN & LAPOINTE, P.C., 900 CHAPEL STREET, SUITE 1201, NEW HAVEN, CT, 06510, US

(73) Assignee: Schwan-STABILO Cosmetics GmbH & Co. KG

(21) Appl. No.: 11/181,172

(22) Filed: Jul. 13, 2005

(30) Foreign Application Priority Data
Mar. 30, 2005 (DE) 10 2005 014 469.1

(51) Int. Cl. B43K 21/16

(52) U.S. Cl. 401/88; 401/98

(57) ABSTRACT

A process for the production of a pencil comprising a front casing portion having a longitudinal axis, and a lead holder with a holding region which is adjustable in its internal dimensions transversely with respect to the longitudinal axis. The lead is at least partially introduced into the holding region while a front end of the holding region is outside the front casing portion of the pencil or is aligned with a front opening of the front casing portion and the front end of the holding region is pushed from the front into the front casing portion.

### BACKGROUND OF THE INVENTION

The invention concerns a process for the production of a pencil comprising a front casing portion having a longitudinal axis, and a lead holder with a holding region which is adjustable in its internal dimensions transversely with respect to the longitudinal axis.

A process for the production of a pencil is known from DE 198 55 210 C2. In that case the lead is not fitted for example in the finished condition into the holding region but is molded simultaneously into the holding region and into the front casing portion. In order to hold the lead in the holding region, such lead holders provide projections or the like on the internal peripheral surface of the holding region. As the lead is molded therein, the projections can be of a comparatively greatly pronounced profile. More specifically they are enclosed in any case by the lead material which is introduced in the liquid condition.

The situation is different however in that case where the lead is not molded in place but is introduced into the holding region, in a prefabricated state. More specifically, in such a case, when the lead holder is of a rigid nature, projections which are possibly provided at the internal surface of the holding region cannot be too pronounced because then the lead can no longer be pushed into the holding region without the risk of destroying it.

U.S. Pat. No 6,309,121 B1 therefore proposes a lead holder having a holding region which comprises pivotable claws so that the holding region is adjustable in its internal dimensions transversely with respect to the longitudinal axis of the front casing portion. In that way it is possible for the lead to be inserted into the holding region while the latter is of large internal dimensions, and thereafter for the internal dimensions to be reduced, whereby the lead is clamped in position, for example by the claws digging into the lead material. That in turn affords the advantage that profile configurations or projections provided on the claws are completely surrounded by lead material.

U.S. Pat. No. 6,309,121 B1 provides that the lead is introduced into the holding region of the lead holder while the lead holder is disposed outside the front casing portion. The lead holder with the lead introduced thereinto at the front is then inserted into the front casing portion from the rear. That causes the claws to close, which were open for introducing the lead into the holding region.

The process which is described in U.S. Pat. No. 6,309,121 B1 and which the invention takes as its basic starting point suffers however from the disadvantage that, in the operation of introducing the lead/lead holder combination into the front casing portion from the rear, the lead soils the inside of the front casing portion because it strikes thereagainst. Preventing the lead from striking against the front casing portion in that way would require a considerable level of precision in the operation of introducing that combination into the front casing portion.

DE 10 2004 005773 A1 describes a process similar to that disclosed in U.S. Pat. No. 6,309,121 B1. More specifically in that case also a lead is introduced into a holding region of a lead holder and the resulting combination is inserted into a front casing portion from the rear.

The object of the invention is to develop the process known from U.S. Pat. No. 6,309,121 B1 in such a way that there is no risk of the front casing portion being soiled by the lead.

### SUMMARY OF THE INVENTION

The object is attained wherein a lead is at least partially introduced into the holding region while a front end of the holding region is outside the front casing portion of the pencil or is aligned with a front opening of the front casing portion and the front end of the holding region is pushed from the front into the front casing portion.

In that respect the invention is based on the realisation that inserting the front end of the lead holder into the front casing portion from the front obviates soiling and fouling of the inside of the front casing portion by the lead.

Preferably the holding region is pushed into the front casing portion through a rear opening of the front casing portion in order to pass into that position in which the lead is introduced.

In other words the lead holder is firstly pushed into the front casing portion from the rear, more specifically until the front end of the holding region is aligned with or projects beyond the front opening of the front casing portion, whereupon the lead is introduced into the holding region and the lead holder is withdrawn again. That ensures that the lead holder is already disposed in the front casing portion when the lead is introduced into its holding region. In that way, when the lead holder is moved together with the lead into its operative position, the lead holder already has a certain degree of hold because it already fits in the front casing portion. That simplifies the production process.

A further preferred embodiment of the invention provides that the internal dimensions of the holding region decrease transversely with respect to the longitudinal axis when the front end of the holding region is inserted into the front casing portion from the front.

In other words, this provides a kind of automatic system. More specifically the lead is fixed in the holding region by the reduction in the internal dimensions. As that occurs simultaneously with the displacement of the front end of the holding region into the front casing portion from the front, there is no need to resort to any further measures.

In a further preferred feature it is provided that the internal dimensions of the holding region increase transversely with respect to the longitudinal axis when the front end of the holding region is pushed out of the front casing portion beyond the front opening of the front casing portion.

In other words, in this embodiment, the holding region of the lead holder automatically spreads whereby the lead can be introduced into the holding region in a particularly simple manner.

Besides the above-described process the invention also provides a pencil comprising a front casing portion having a longitudinal axis, and a lead holder which at least partially fits into the front casing portion, wherein the lead holder has a holding region for at least partially receiving a lead and the holding region is adjustable in its internal dimensions transversely with respect to the longitudinal axis.

According to the invention it is provided that a front end of the holding region fits through a front opening of the front casing portion.

In other words the invention also provides a pencil which can be assembled after a lead has been introduced into the holding region of its lead holder, without the lead having to be inserted from the rear side of the front casing portion, thereby achieving the advantages described hereinbefore.

Preferably the holding region has at least one claw which is displaceable in a direction transversely with respect to the longitudinal axis.

That configuration is mechanically particularly simple.

In a further preferred feature the holding region of the lead holder is biased in a direction of larger internal dimensions transversely with respect to the longitudinal axis.

That configuration results in the spreading of the holding region, which has already been mentioned hereinbefore, thereby ensuring that the lead can be particularly easily introduced into the holding region.

A further preferred embodiment provides that the front casing portion has a region for receiving the holding region of the lead holder, the internal dimensions of which are such that the holding region fits in only in an operative condition in which it is adjusted in the sense of a reduction in its internal dimensions transversely with respect to the longitudinal axis.

In other words, the operation of introducing the holding region into the above-mentioned receiving region of the front casing portion, without entailing further measures, provides that the internal dimensions of the holding region are reduced in order to fix the lead in place. Therefore, moving the holding region into the above-mentioned receiving region is sufficient to fix the lead without the necessity to have recourse to further measures.

In a further preferred feature there is provided a rotary drive for axial displacement of the lead holder with respect to the front casing portion.

That affords a particularly simple possible way of displacing the lead with respect to the front casing portion, for example in order to compensate for consumption of a self-consuming lead or in order to protect the lead from damage by retracting it into the front casing portion.

Finally in a particularly preferred feature there is provided a shaft, wherein rotation of the shaft with respect to the front casing portion causes axial displacement of the lead holder with respect to the front casing portion.

That configuration is in turn mechanically particularly simple.

### BRIEF DESCRIPTION OF THE DRAWINGS

The invention is described in greater detail hereinafter by means of a preferred embodiment by way of example with reference to the accompanying drawing in which:

FIG. 1 shows a view in longitudinal section of a structural group of a pencil in accordance with a particularly preferred embodiment of the invention,

FIG. 2 shows the structural group of FIG. 1 but turned through 90° about a longitudinal axis,

FIG. 3 shows the same view as in FIG. 1 but at a later stage in the production process,

FIG. 4 shows the same view as in FIG. 3 but at a later stage in the production process, and

FIG. 5 shows a view in longitudinal section of the finished pencil.

### DETAILED DESCRIPTION

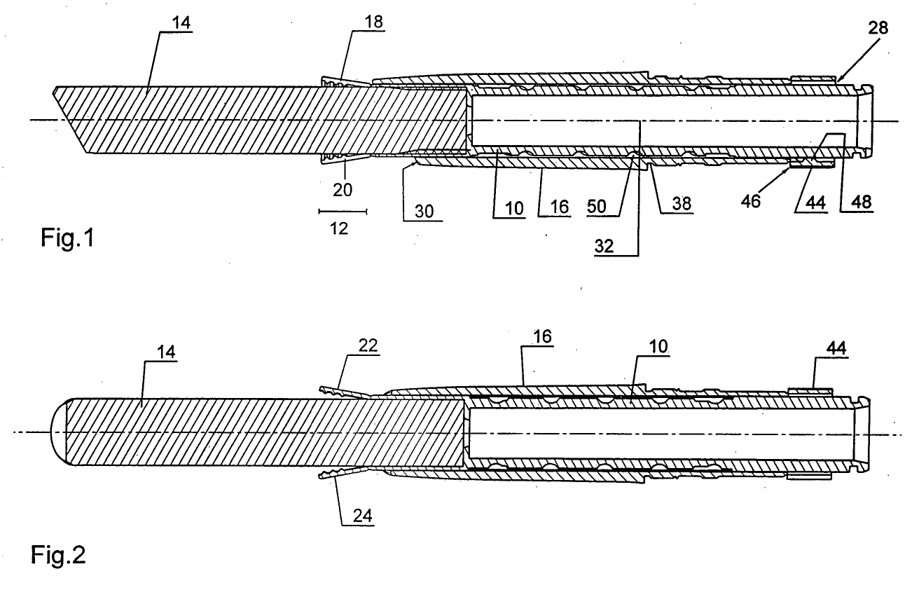

FIG. 1 shows a lead holder 10 having a holding region 12 and a lead 14 fitted into the lead holder 10. The lead holder 10 fits in a front casing portion 16. It has claws 18, 20, 22, 24. The claws have teeth of which one is identified by way of example by reference 26. The claws are elastically biased in the opening direction.

In order to move into the position shown in FIGS. 1 and 2 within the front casing portion 16, the lead holder 10 is pushed into the front casing portion 16 through a rear opening 28. A front opening of the front casing portion 16 is in comparison identified by reference 30.

The lead holder 10 is admittedly displaceable axially with respect to the front casing portion 16, but it is not rotatable about a common longitudinal axis 32. Provided for that purpose are ribs which are not shown in detail in the drawing. Alternatively the external contour of the lead holder 10 and the internal contour of the front casing portion 16 can also be of a non-round configuration in cross-section.

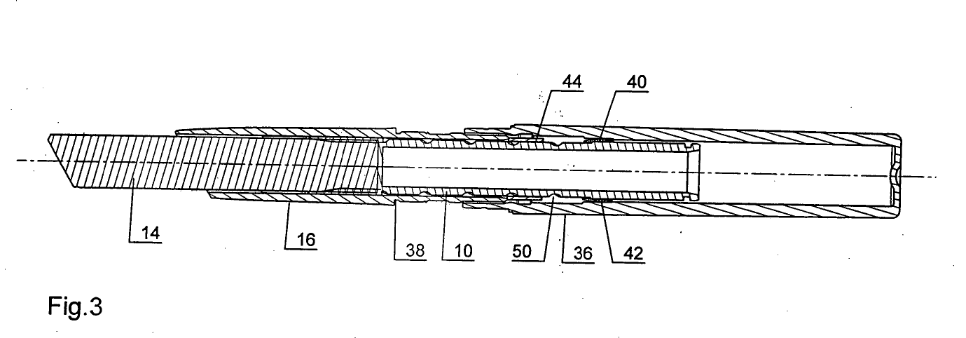

For further assembly of the pencil the lead holder 10 is pushed rearwardly within the front casing portion 16, so that it is in the position shown in FIG. 3. In that position the claws 18, 20, 22, 24 are pivoted inwardly by the internal peripheral surface of the receiving region identified by reference 34 in FIG. 3, whereby the teeth 26 press into the lead 14 and fix the lead 14 in the holding region 12 and thus in the lead holder 10.

When the lead holder 10 and thus the lead 14 are pulled into the front casing portion 16 in that way, there is no risk of the lead 14 coming into contact with and accordingly soiling the inside of the front casing portion 16.

In the next step a shaft 36 is pushed from the rear on to the front casing portion 16 until a nose (not shown) latches into an annular groove 38 in the front casing portion 16. In that way the shaft 36 is held axially immovably but rotatably with respect to the front casing portion 16.

When the shaft 36 latches into the groove 38, ribs 40, 42 come into engagement with a ring 44 which is provided integrally with the front casing portion 16. A desired-rupture location 46 is provided between the ring 44 and the remaining part of the front casing portion 16. The ring 44 can be adapted to be radially expansible, for example by means of a longitudinal slot, to simplify the operation of pushing the lead holder 10 into position.

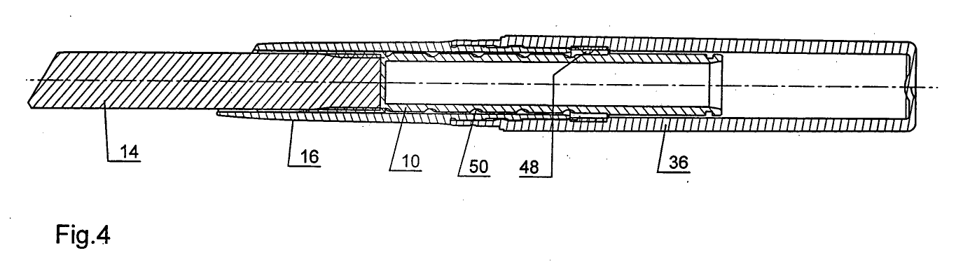

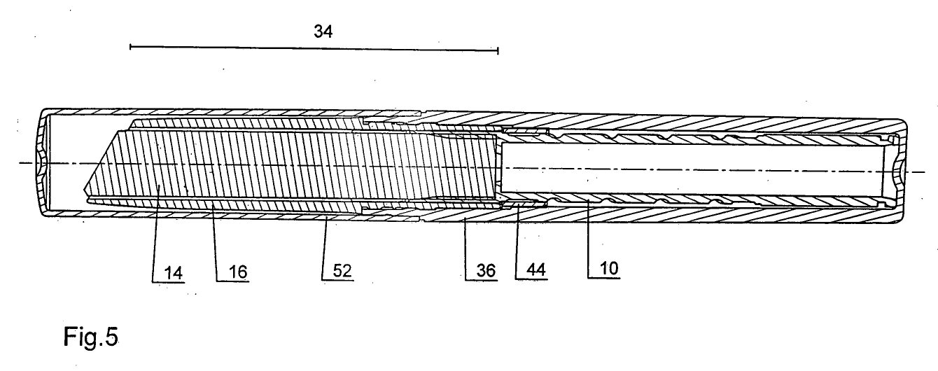

When now, after the shaft 36 is engaged into the groove 38, that is to say in the position shown in FIG. 4, the shaft 36 is rotated about the longitudinal axis 32 with respect to the front casing portion 16, the shaft 36 entrains the ring 44 in the direction of rotary movement because of the ribs 40, 42, so that the desired-rupture location 46 breaks. In that way, a screwthread element 48 on the ring 44 can move along a spiral groove 50 on the lead holder 10, whereby the lead holder 10 is axially displaced both with respect to the front casing portion 16 and also with respect to the shaft 36.

Thus for example the lead 14, as shown in FIG. 4, is screwed very far out of the front casing portion 16, whereas in the view shown in FIG. 5 it is retracted to the maximum extent. FIG. 5 moreover also shows a protective cap 52.

The features of the invention disclosed in the foregoing description, the claims and the drawing can be essential both individually and also in any combinations for implementing the invention in its various embodiments.

1. A process for the production of a pencil comprising
a front casing portion (16) having a longitudinal axis (32), and
a lead holder (10) with a holding region (12) which is adjustable in internal dimensions transversely with respect to the longitudinal axis (32), wherein
a lead (14) is at least partially introduced into the holding region (12) while a front end of the holding region (12) is outside the front casing portion (16) of the pencil or is aligned with a front opening (30) of the front casing portion (16), and
the front end of the holding region (12) is pushed from the front into the front casing portion (16).

2. A process as set forth in claim 1, wherein the holding region (12) is pushed into the front casing portion (16) through a rear opening (28) of the front casing portion (16) in order to pass into that position in which the lead (14) is introduced.

3. A process as set forth in claim 1, wherein the internal dimensions of the holding region (12) decrease transversely with respect to the longitudinal axis (32) when the front end of the holding region (12) is inserted into the front casing portion (16) from the front.

4. A process as set forth in claim 1, wherein the internal dimensions of the holding region (12) increase transversely with respect to the longitudinal axis when the front end of the holding region (12) is pushed out of the front casing portion (16) beyond the front opening (30) of the front casing portion (16).

5. A pencil comprising
a front casing portion (16) having a longitudinal axis (32), and
a lead holder (10) which at least partially fits into the front casing portion (16), wherein the lead holder (10) has a holding region (12) for at least partially receiving a lead (14) and the holding region (12) is adjustable in its internal dimensions transversely with respect to the longitudinal axis (32), wherein a front end of the holding region (12) fits through a front opening (30) of the front casing portion (16).

6. A pencil as set forth in claim 5, wherein the holding region (12) has at least one claw (18, 20, 22, 24) which is displaceable in a direction transversely with respect to the longitudinal axis (32).

7. A pencil as set forth in claim 5, wherein the holding region (12) is biased in a direction of larger internal dimensions transversely with respect to the longitudinal axis (32).

8. A pencil as set forth in claim 5, wherein the front casing portion (16) has a region (34) for receiving the holding region (12) of the lead holder (10), the internal dimensions of which are such that the holding region (12) fits in only in an operative condition in which it is adjusted in the sense of a reduction in its internal dimensions transversely with respect to the longitudinal axis (32).

9. A pencil as set forth in claim 5, including a rotary drive (44, 48; 10, 50) for axial displacement of the lead holder (10) with respect to the front casing portion (16).

10. A pencil as set forth in claim 5, including a shaft (36), and means for rotation of the shaft (36) with respect to the front casing portion (16) for axial displacement of the lead holder (10) with respect to the front casing portion (16).
